(19) United States
(12) Patent Application Publication
(10) Pub. No.: US 2015/0325928 A1
(43) Pub. Date: Nov. 12, 2015

(54) MULTIBAND ANTENNA

(71) Applicant: GEMTEK TECHNOLOGY CO., LTD., HSINCHU (TW)

(72) Inventor: CHIA- KANG CHAO, HSINCHU (TW)

(21) Appl. No.: 14/323,218

(22) Filed: Jul. 3, 2014

(30) Foreign Application Priority Data
May 9, 2014 (TW) 103208158

(51) Int. Cl. H01Q 21/30; H01Q 21/26

(52) U.S. Cl. CPC H01Q 21/30; H01Q 21/26

(57) ABSTRACT

A multiband antenna is disclosed, which comprises: a low-band antenna assembly, a mid-band antenna assembly, a high-band antenna assembly and a bottom panel. In an embodiment, the low-band antenna assembly is composed of a first dipole antenna and a second dipole antenna that are arranged intersecting with each other; the mid-band antenna assembly is composed of a plurality of connecting mid-band antennas; the high-band antenna assembly is composed of a plurality of connecting high-band antennas; the bottom panel is provided for the low-band antenna assembly, the mid-band antenna assembly and the high-band antenna assembly to be disposed thereon in a manner that the low-band antenna assembly is disposed on top of the mid-band antenna assembly and the high-band antenna assembly for enabling the multiband antenna to achieve optimal operation performance without causing the three antenna assemblies to interfere with one another.

### CROSS-REFERENCE TO RELATED APPLICATION

This application claims the benefit of Taiwan Patent Application No. 103208158, filed on May 9, 2014, in the Taiwan Intellectual Property Office, the disclosure of which is incorporated herein in its entirety by reference.

### FIELD OF THE INVENTION

The present invention relates to a multiband antenna, and more particularly, to a three-band antenna with optimal gain and performance that is achieved by the arrangement of three specific antenna band designs on a bottom panel.

### BACKGROUND OF THE INVENTION

With rapid advance of wireless communication technology that is being encouraged and fueled by the fierce market competition, there is a variety of communication protocols with high-speed data transmission ability that are becoming available, such as Long Term Evolution (LTE). Moreover, in order to design an antenna capable of operating at different frequencies and thus is being adapted for various wireless communication networks, the design of a multiband antenna is becoming more and more common and essential, which leads to the generation of all kinds of multiband antennas. Nevertheless, there are still a lot of improvements required in the design of those currently available multiband antennas.

Generally speaking, to achieve an antenna capable of operating in multiple bands of frequencies, it is required to arrange more than on radiation elements of different operating frequencies on one substrate. That is, to achieve a three-band antenna, three should be three radiation elements of different operating frequencies fitted in the antenna. Consequently, those conventional multiband antennas are generally larger in size, resulting that the use of those multiband antennas is greatly restricted due to their larger size and thus their practicability is minimized

Moreover, since there can be more than one radiation elements of different operating frequencies being disposed on one substrate, interferences can be inevitable. As the result, the performance indexes of those conventional multiband antennas, such as gains and efficiencies, can be decreased significantly. Therefore, the performance of a common multiband antenna may not be as good as other types of antennas.

Therefore, it is in need of a multiband antenna of greatly performance efficiency that not only is small in size and versatile in usage, but also can meet the current requirement of high-speed data transmission.

### SUMMARY OF THE INVENTION

In view of the disadvantages of prior art, the object of the present invention is to provide a multiband antenna capable of overcoming the conventional problems, such as oversized and poor performance.

To achieve the above object, the present invention provides a multiband antenna, which comprises: a low-band antenna assembly, at least one mid-band antenna assembly, at least one high-band antenna assembly and a bottom panel. In an embodiment, the low-band antenna assembly is composed of a first dipole antenna and a second dipole antenna that are arranged intersecting with each other; each mid-band antenna assembly is composed of a plurality of connecting mid-band antennas; each high-band antenna assembly is composed of a plurality of connecting high-band antennas; the bottom panel is provided for the low-band antenna assembly, the at least one mid-band antenna assembly and the at least one high-band antenna assembly to be disposed thereon in a manner that the low-band antenna assembly is disposed on top of the at least one mid-band antenna assembly and the at least one high-band antenna assembly.

To achieve the above object, the present invention further provides a multiband antenna, which comprises: a first-band antenna assembly, a plurality of second-band antenna assemblies and a bottom panel. In an embodiment, first-band antenna assembly is composed of a first dipole antenna and a second dipole antenna that are arranged intersecting with each other; each second-band antenna assemblies is composed of a plurality of connecting second-band antennas, and the operating frequency of the second-band antenna assemblies is higher than the operating frequency of the first-band antenna assembly; the bottom panel is provided for the first-band antenna assembly and the second-band antenna assemblies to be disposed thereon in a manner that the first-band antenna assembly is disposed on top of the second-band antenna assemblies.

In an embodiment, the bottom panel is formed in a shape selected from the group consisting of: a round shape, an oval, a rectangle, a diamond, a parallelogram, and a polygon.

In an embodiment, each of the mid-band antennas and the high-band antennas is an antenna selected from the group consisting of: a patch antenna, a dipole antenna, and a slot antenna.

In an embodiment, the operating frequency of the mid-band antenna assembly is ranged between 1.5 times and 2 times the operating frequency of the low-band antenna assembly, while the operating frequency of the high-band antenna assembly is about higher than 2 times the operating frequency of the low-band antenna assembly.

In an embodiment, the sizes and the heights of disposition of the low-band antenna assembly, the mid-band antenna assembly and the high-band antenna assembly are increased or decreased proportionally according to their operating frequencies.

In an embodiment, the low-band antenna assembly, the mid-band antenna assembly and the high-band antenna assembly are alternatively disposed on a rectangle-shaped bottom panel.

In an embodiment, the first dipole antenna and the second dipole antenna are arranged orthogonal to each other.

In an embodiment, the mid-band antenna assembly and the high-band antenna assembly are respectively and alternatively disposed on two diagonal lines of the rectangle-shaped bottom panel, while the low-band antenna assembly is alternatively disposed on top of the mid-band antenna assembly and the high-band antenna assembly without having the low-band antenna assembly to crisscross the mid-band antenna assembly and the high-band antenna assembly.

In an embodiment, the first dipole antenna, the second dipole antenna, the plural high-band antennas and the plural mid-band antennas are disposed respectively on a substrate while being arranged at different heights on the rectangle-shaped bottom panel by the use of a fixing structure; the signals of the first dipole antenna and the second dipole antenna are fed to the rectangle-shaped bottom panel via transmission lines; the plural high-band antennas and the plural mid-band antennas are patch antennas, while each of the mid-band antennas further comprises matching circuit transmission lines and the signals thereof are being feed-in via feed-in points of the rectangle-shaped bottom panel, whereas the impedance matching of the plural mid-band antennas is achieved by the connecting the matching circuit transmission lines; and each of the high-band antennas further comprises matching circuit transmission lines and the signals thereof are being feed-in via feed-in points of the rectangle-shaped bottom panel, whereas the impedance matching of the plural high-band antennas is achieved by the connecting the matching circuit transmission lines.

In an embodiment, the first dipole antenna and the second dipole antenna are disposed respectively on a substrate while allowing the signals thereof to be fed to the rectangle-shaped bottom panel via transmission lines; the plural high-band antennas and the plural mid-band antennas are metal patch antennas, and are respectively disposed on a metal substrate into a framework of excitation and transmission while being arranged at different heights on the rectangle-shape bottom panel which has a metal layers formed therein; the plural mid-band antennas are connected to one another via two transmission lines of the metal substrate, while the plural high-band antennas are also connected to one another via two transmission lines of the metal substrate.

In an embodiment, the first dipole antenna and the second dipole antenna are disposed respectively on a substrate while allowing the signals thereof to be fed to the rectangle-shaped bottom panel via transmission lines; the plural high-band antennas and the plural mid-band antennas are metal patch antennas that are arranged at different heights on the rectangle-shape bottom panel while allowing each to contact to the rectangle-shaped bottom panel in a direct manner so as to enable the signals thereof to be fed-in; and the plural mid-band antennas are connected to one another via two transmission lines, while the plural high-band antennas are also connected to one another via two transmission lines.

In an embodiment, the first dipole antenna and the second dipole antenna are disposed respectively on a substrate while allowing the signals thereof to be fed to the rectangle-shaped bottom panel via transmission lines; the plural high-band antennas and the plural mid-band antennas are dipole antennas that are disposed respectively on a reflective substrate while being arranged respectively at different heights on the rectangle-shape bottom panel; the high-band antenna assembly is composed of two sets of high-band antennas that are arranged orthogonal to each other, and the two sets of high-band antennas are connected to each other via transmission lines for signal feed-in; and the mid-band antenna assembly is composed of two sets of mid-band antennas that are arranged orthogonal to each other, and the two sets of mid-band antennas are connected to each other via transmission lines for signal feed-in.

In an embodiment, the first dipole antenna and the second dipole antenna are disposed respectively on a substrate while allowing the signals thereof to be fed to the rectangle-shaped bottom panel via transmission lines; the plural high-band antennas and the plural mid-band antennas are slot antennas that are disposed respectively on a reflective substrate while being arranged respectively at different heights on the rectangle-shape bottom panel; and the plural mid-band antennas are connected to one another via two transmission lines for signal feed-in, while the plural high-band antennas are also connected to one another via two transmission lines for signal feed-in.

In an embodiment, the first dipole antenna and the second dipole antenna are disposed respectively on a substrate while allowing the signals thereof to be fed to the rectangle-shaped bottom panel via transmission lines; the plural high-band antennas and the plural mid-band antennas are metal patch antennas that are arranged at a same height on the rectangle-shape bottom panel while allowing each to contact to the rectangle-shaped bottom panel in a direct manner so as to enable the signals thereof to be fed-in; and the plural mid-band antennas and the plural high-band antennas are serially connected to one another via transmission lines.

The multiband antenna of the present invention has the following advantages:
(1) By arranging more than three antennas of different operating frequencies at different heights on a bottom panel, the space utilization efficiency of the relating multiband antenna can be enhanced effectively so that the size of the multiband antenna is minimized.
(2) By the specific design of the multiband antenna for arranging more than three antennas of different operating frequencies on one substrate without causing the three antennas to interfere with one another, the performance of the multiband antenna is optimized.
(3) The design of the multiband antenna of the present invention relating to its configuration and parts arrangement can be varied in many ways for achieving different characteristics in beam width, polarization and so on, the multiband antenna is very flexible in usage and thus can be applied in various applications.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing a multiband antenna according to a first embodiment of the present invention.

FIG. 2 is a first exemplary view of a multiband antenna according to a second embodiment of the present invention.

FIG. 3 is a second exemplary view of the multiband antenna according to the second embodiment of the present invention.

FIG. 4 is a third exemplary view of the multiband antenna according to the second embodiment of the present invention.

FIG. 5 is a fourth exemplary view of the multiband antenna according to the second embodiment of the present invention.

FIG. 6 is a fifth exemplary view of the multiband antenna according to the second embodiment of the present invention.

FIG. 7 is a sixth exemplary view of the multiband antenna according to the second embodiment of the present invention.

FIG. 8 is a seventh exemplary view of the multiband antenna according to the second embodiment of the present invention.

FIG. 9 is an eighth exemplary view of the multiband antenna according to the second embodiment of the present invention.

FIG. 10 is a schematic diagram showing a multiband antenna according to a third embodiment of the present invention.

FIG. 11 is a schematic diagram showing a multiband antenna according to a fourth embodiment of the present invention.

FIG. 12A is a first exemplary view of a multiband antenna according to a fifth embodiment of the present invention.

FIG. 12B is a second exemplary view of the multiband antenna according to the fifth embodiment of the present invention.

FIG. 13 is a schematic diagram showing a multiband antenna according to a sixth embodiment of the present invention.

FIG. 14 is a schematic diagram showing a multiband antenna according to a seventh embodiment of the present invention.

FIG. 15 is a schematic diagram showing a multiband antenna according to an eighth embodiment of the present invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

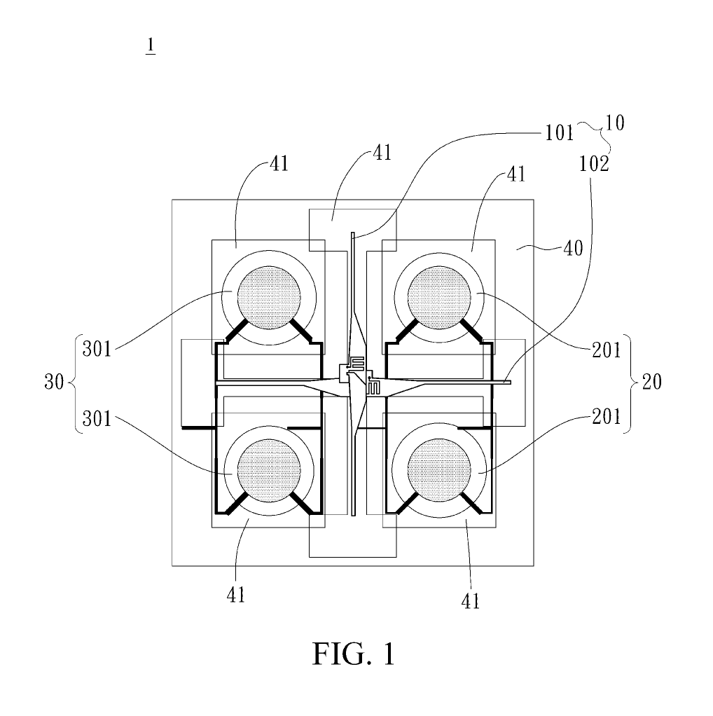

Please refer to FIG. 1, which is a schematic diagram showing a multiband antenna according to a first embodiment of the present invention. As shown in FIG. 1, the multiband antenna 1 includes a low-band antenna assembly 10, a mid-band antenna assembly 20, a high-band antenna assembly 30 and a bottom panel 40. The low-band antenna assembly 10 is composed of a first dipole antenna 101 and a second dipole antenna 102 that are arranged intersecting with each other by an angle while allowing the signals thereof to be fed into the bottom panel 40. The mid-band antenna assembly 20 is composed of a plurality of mid-band antennas 201 that are connecting to one another into an antenna array. In this embodiment, the mid-band antenna assembly 20 is formed by two connecting mid-band antennas 201. Similarly, the high-band antenna assembly 30 is composed of a plurality of high-band antennas 301 that are connecting to one another into an antenna array. In this embodiment, the high-band antenna assembly 30 is formed by two connecting high-band antennas 301

It is noted that each of the mid-band antennas 201 and the high-band antennas 301 can be an antenna selected from the group consisting of: a patch antenna, a dipole antenna, and a slot antenna.

Moreover, the first dipole antenna 101, the second dipole antenna 102, the plural mid-band antennas 201 and the plural high-band antennas 301 are respectively disposed on a substrate 41, while each of the substrates 41 are mounted respectively to the bottom panel 40 by the use of fixing elements, such as screws. In addition, the low-band antenna assembly 10, the mid-band antenna assembly 20 and the high-band antenna assembly 30 are arranged respectively at different heights on the bottom panel 40, in a manner that the low-band antenna assembly 10 is disposed on top of the mid-band antenna assembly 20 and the high-band antenna assembly 30, while the mid-band antenna assembly 20 is disposed on top of the high-band antenna assembly 30.

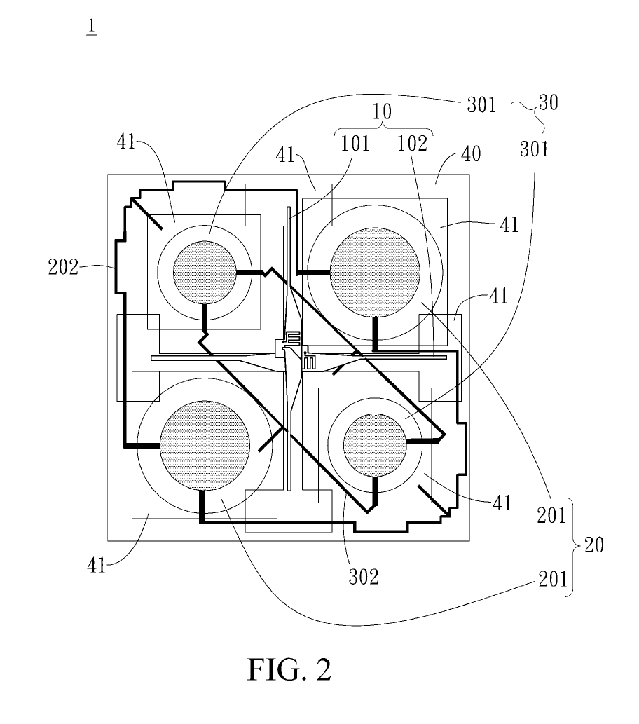

Please refer to FIG. 2, which is a first exemplary view of a multiband antenna according to a second embodiment of the present invention. As shown in FIG. 2, the multiband antenna 1 includes a low-band antenna assembly 10, a mid-band antenna assembly 20, a high-band antenna assembly 30 and a bottom panel 40. The low-band antenna assembly 10 is composed of a first dipole antenna 101 and a second dipole antenna 102 that are arranged orthogonal to each other while allowing the signals thereof to be fed into the bottom panel 40 via cables, in which the first dipole antenna 101 can be used as the primary antenna while the second dipole antenna 102 can be used as the diversity antenna. Moreover, the mid-band antenna assembly 20 is a dual-feed patch antenna array consisting of two connecting mid-band antennas 201; and similarly, the high-band antenna assembly 30 is a dual-feed patch antenna array consisting of two connecting high-band antennas 301.

Similarly, the first dipole antenna 101, the second dipole antenna 102, the plural mid-band antennas 201 and the plural high-band antennas 301 are respectively disposed on a substrate 41, while each of the substrates 41 are mounted respectively to the bottom panel 40, whereas the bottom panel 40 can be made of a RO board for reducing wear and tear while the substrate 41 can be a FR4 board. In addition, each of the mid-band antennas 201 and the high-band antennas 301 can be a circular-shaped patch antenna. In this embodiment, the low-band antenna assembly 10, each of the antenna assembly, including the mid-band antenna assembly 20 and the high-band antenna assembly 30, is the composition of a plurality of antennas, so that they can be applied in many Multi-input Multi-output (MIMO) applications.

In this embodiment, the operating frequency of the mid-band antenna assembly 20 is ranged between 1.5 times and 2 times the operating frequency of the low-band antenna assembly 10, while the operating frequency of the high-band antenna assembly 30 is about 2 times the operating frequency of the mid-band antenna assembly 20. Preferably, the operating frequency of the mid-band antenna assembly 20 is higher than 2 times the operating frequency of the low-band antenna assembly 10, while the operating frequency of the high-band antenna assembly 30 is higher than 3 times the operating frequency of the mid-band antenna assembly 20. In an LTE application for example, the operating frequency of the low-band antenna assembly 10 can be defined at Band 20, i.e. U:832-862M D:791-821M, consequently the operating frequency of the mid-band antenna assembly 20 is defined at Band 3, i.e. U:1710-1788M D:1805-1880M while the operating frequency of the high-band antenna assembly 30 is defined at Band 7, i.e. U:2500-2570 M D:2620-2690M. However, in the other embodiments, the operating frequency of the low-band antenna assembly 10 can be under 1000 MHz, the operating frequency of the mid-band antenna assembly 20 can be ranged between 1000˜2200 MHz, and the operating frequency of the high-band antenna assembly 30 can be higher than 2200 MHz. Nevertheless, preferably the operating frequency of the low-band antenna assembly 10 should be ranged between 700 MHz and 1000 MHz, the operating frequency of the mid-band antenna assembly 20 should be ranged between 1700˜2200 MHz, and the operating frequency of the high-band antenna assembly 30 should be ranged between 2200 MHz and 3000 MHz.

In FIG. 2, the low-band antenna assembly 10, the mid-band antenna assembly 20 and the high-band antenna assembly 30 are alternatively disposed on the bottom panel 40 which is formed into a rectangle shape. In this embodiment, the mid-band antenna assembly 20 and the high-band antenna assembly 30 are respectively and alternatively disposed on two diagonal lines of the rectangle-shaped bottom panel 40, while the low-band antenna assembly 10 is alternatively disposed on top of the mid-band antenna assembly 20 and the high-band antenna assembly 30 without having the low-band antenna assembly 10 to crisscross the mid-band antenna assembly 20 and the high-band antenna assembly 30.

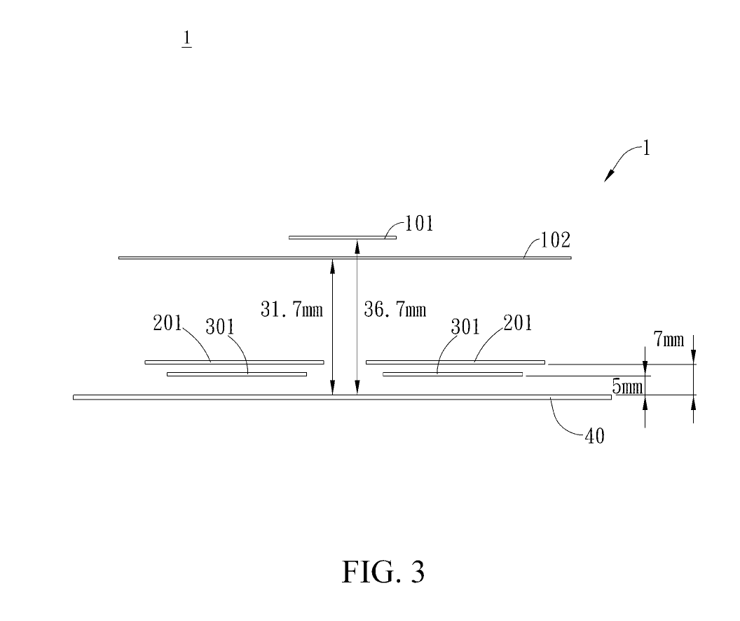

Please refer to FIG. 3, which is a second exemplary view of the multiband antenna according to the second embodiment of the present invention. In FIG. 3. a side view of an exemplary multiband antenna is provided for revealing how the three antenna assemblies of different operating frequencies are arranged at different heights on the bottom panel.

In the embodiment shown in FIG. 3, the two high-band antennas 301 of the high-band antenna assembly 30 are arranged 5 mm above the bottom panel 40; the two mid-band antennas 201 of the mid-band antenna assembly 20 are arranged 7 mm above the bottom panel 40; whereas the primary antenna 101 of the low-band antenna assembly 10 is arranged about 36.7 mm above the bottom panel 40 while the diversity antenna 102 of the low-band antenna assembly 10 is arranged about 31.7 mm above the bottom panel 40. Thereby, the ratio between the width of the bottom panel 40, the height of the low-band antenna assembly 10, the height of the mid-band antenna assembly 20 and the height of the high-band antenna assembly 30 is about 210:36.7:7:5.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

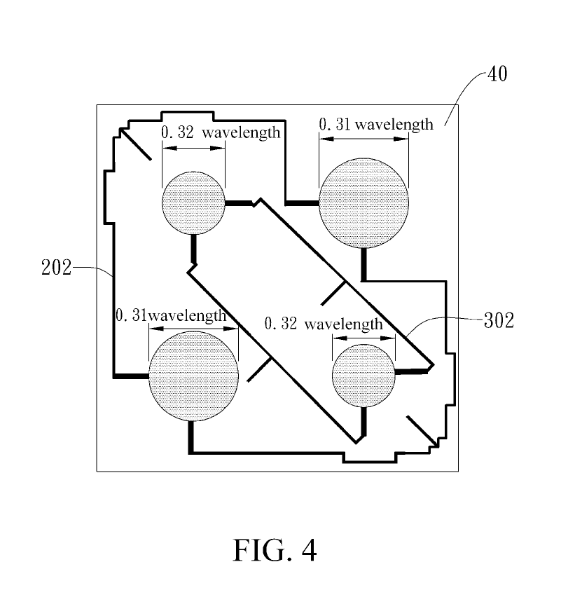

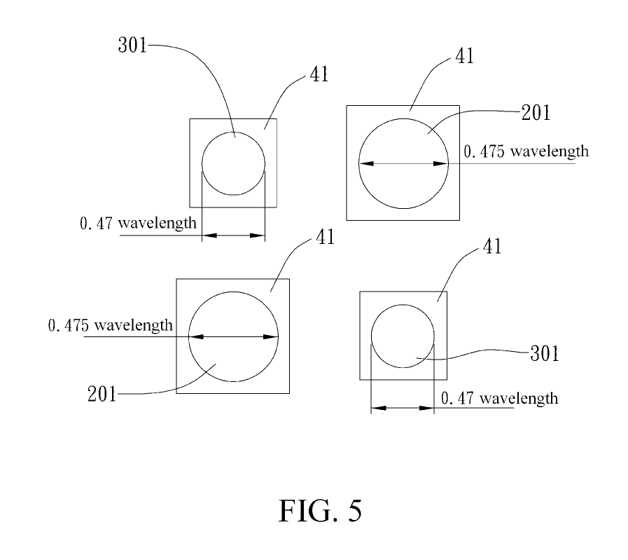

Please refer to FIG. 4 and FIG. 5, which are respectively a third exemplary view and a fourth exemplary view of the multiband antenna according to the second embodiment of the present invention. In FIG. 4, the layout of the bottom panel 40 is disclosed, in which the diameter of the mid-band part is about 0.31 times the wavelength of Band 3, the diameter of the high-band part is about 0.32 times the wavelength of Band 7.

In FIG. 5, the plural mid-band antennas 201 and the plural high-band antennas 301 are disposed respectively on a substrate 41 while being arranged at different heights on the bottom panel 40. In this embodiment, the diameter of the mid-band antenna 201 is about 0.475 times the wavelength of its operating frequency and the diameter of the high-band antenna 301 is about 0.47 times the wavelength of its operating frequency. Thus, the ratio between the diameter of the bottom panel 40, the height of the mid-band antenna 201 and the diameter of the high-band antenna 301 is about 210:79:54. Moreover, each of the mid-band antennas 201 is composed of two matching circuit transmission lines 202 (50 ohm) and the signals thereof are being feed-in via feed-in points of the bottom panel 40, whereas the impedance matching of the plural mid-band antennas 201 is achieved by the connecting the corresponding matching circuit transmission lines 202 of the mid-band antennas 201 (parallelly connected after being converted into 100 ohm); and similarly each of the high-band antennas 301 is composed of two matching circuit transmission lines 302 and the signals thereof are being feed-in via feed-in points of the bottom panel 40, whereas the impedance matching of the plural high-band antennas 301 is achieved by the connecting the corresponding matching circuit transmission lines 302. In addition, there can be a via formed at the center of each of the mid-band antennas 201 and the high-band antennas 301 for preventing lightning strike. It is noted that the connection manner described above is known to those skilled in the art and thus will not be described further herein.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

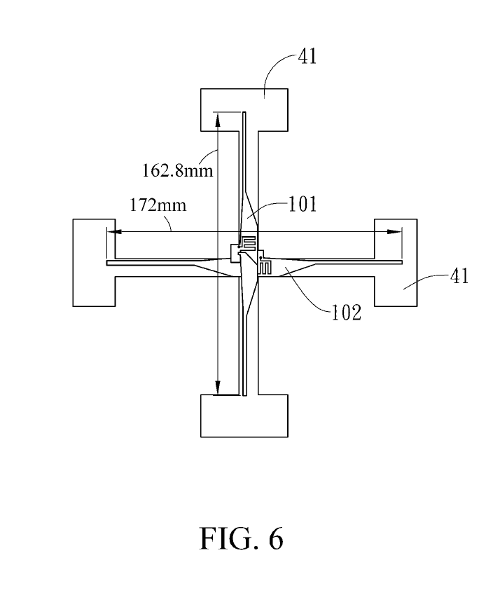

Please refer to FIG. 6, which is a fifth exemplary view of the multiband antenna according to the second embodiment of the present invention. In this embodiment, the length of the first dipole antenna 101 is 162.8 mm and the length of the second dipole antenna 102 is 172 mm. Thus, the ratio between the width of the bottom panel 40, the length of the first dipole antenna 101 and the length of the second dipole antenna 102 is about 210:163:172. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

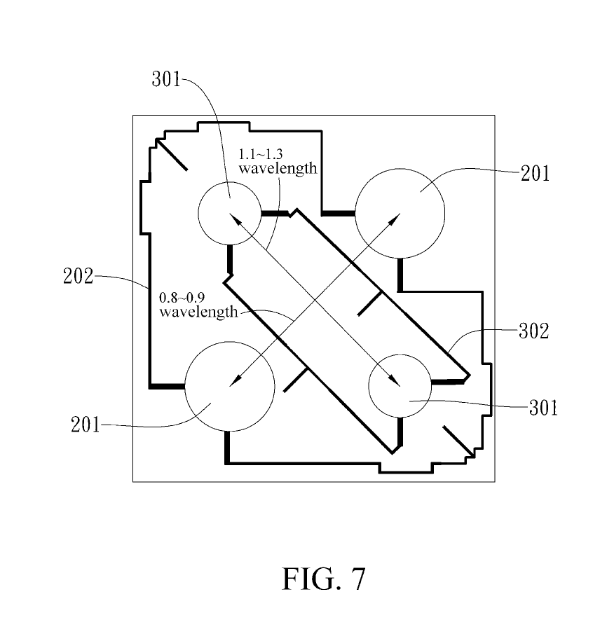

Please refer to FIG. 7, which is a sixth exemplary view of the multiband antenna according to the second embodiment of the present invention. Since the operation of the low-band antenna assembly 10 is surely to interfere the operation of the mid-band antenna assembly 20 and the high-band antenna assembly 30, a specially arrangement is required so as to enable the three antenna assemblies to achieve their optimal performance, In FIG. 7, the distance between the centers of the two high-band antennas 301 is ranged between 1.1˜1.3 times the wavelength of its operating frequency, while the distance between the centers of the two mid-band antennas 201 is ranged between 0.8˜0.9 times the wavelength of its operating frequency.

Since the conventional multiband antennas are generally larger in size by their poor layout designs, the use of those multiband antennas can be greatly restricted and thus their practicability is minimized. On the other hand, by the specific arrangement of more than three antenna assemblies of different operating frequencies at different heights on a bottom panel, the space utilization efficiency of the bottom panel can be enhanced effectively so that the size of the multiband antenna is minimized and consequently the restriction to the use of those multiband antennas is released and thus their practicability is improved significantly.

In addition, since there can be more than one radiation elements of different operating frequencies in any prior-art multiband antenna that are to be disposed on one substrate, interferences therebetween can be inevitable. As the result, the performance of those conventional multiband antennas can be decreased significantly. On the other hand, by the specific design of the multiband antenna in the present invention for optimizing the distances between antennas, the interference can be greatly reduced.

Moreover, in the embodiments of the present invention, there can be dipole antennas and patch antennas being used simultaneously in the multiband antenna, while each antenna assembly used in the multiband antenna can be an array of a plurality of antennas, by that the gain thereof is enhanced and thus can be used in many MIMO applications with high-speed data transmission ability.

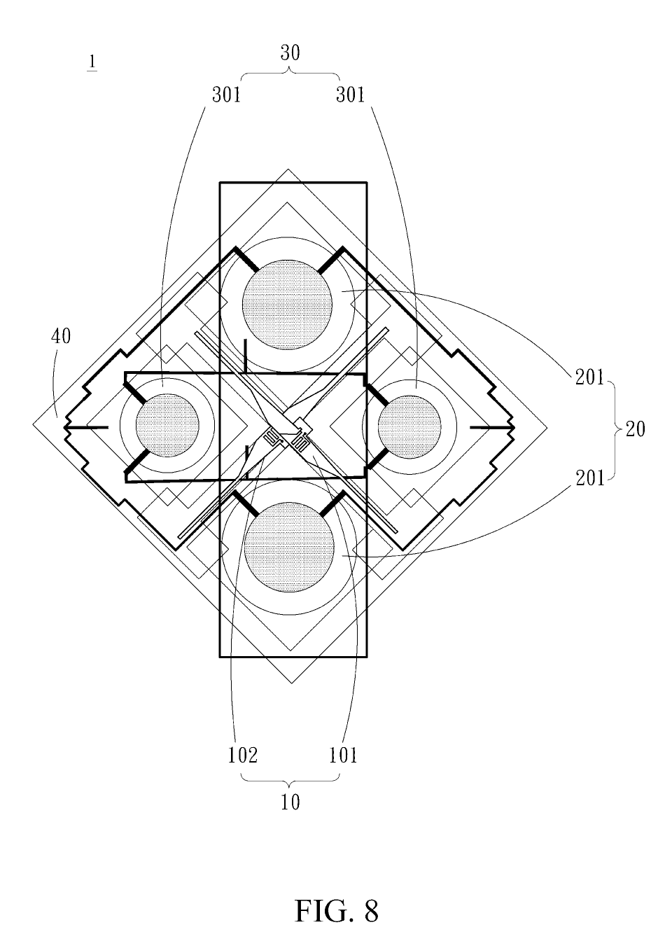

Please refer to FIG. 8, which is a seventh exemplary view of the multiband antenna according to the second embodiment of the present invention. It is noted that the design of the multiband antenna 1 of the present invention relating to its configuration and parts arrangement can be varied in many ways for achieving different characteristics in horizontal beamwidth, vertical beamwidth and polarization, etc., the multiband antenna 1 can be very flexible in usage and thus can be applied in various applications. By the arrangement shown in FIG. 8, both the low-band antenna assembly 10 (Band 20) and the mid-band antenna assembly 20 (Band 3) can achieve 60 deg in horizontal beamwidth, 30 deg in vertical beamwidth and +/−45 deg in polarization.

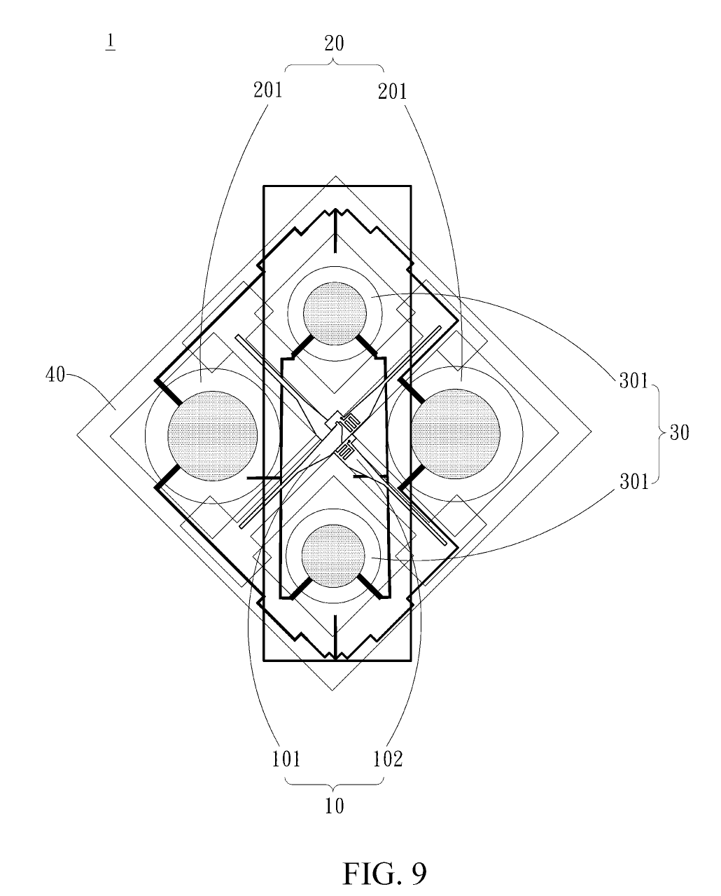

Please refer to FIG. 9, which is an eighth exemplary view of the multiband antenna according to the second embodiment of the present invention. By the arrangement shown in FIG. 9, both the low-band antenna assembly 10 (Band 20) and the high-band antenna assembly 30 (Band 7) can achieve 60 deg in horizontal beamwidth, 30 deg in vertical beamwidth and +/−45 deg in polarization. However, in a condition when the beamwidths are not specified while a polarization of 0/90 deg is required, the arrangement of FIG. 2 can be adopted and used in various applications.

It is obvious to those skilled in the art that the above description only relates to some preferred embodiments of the present invention. There can be a variety of other arrangements capable of being achieved in the multiband antenna of the present invention for achieving different characteristics relating to beamwidth and polarization that can be used in many other different applications.

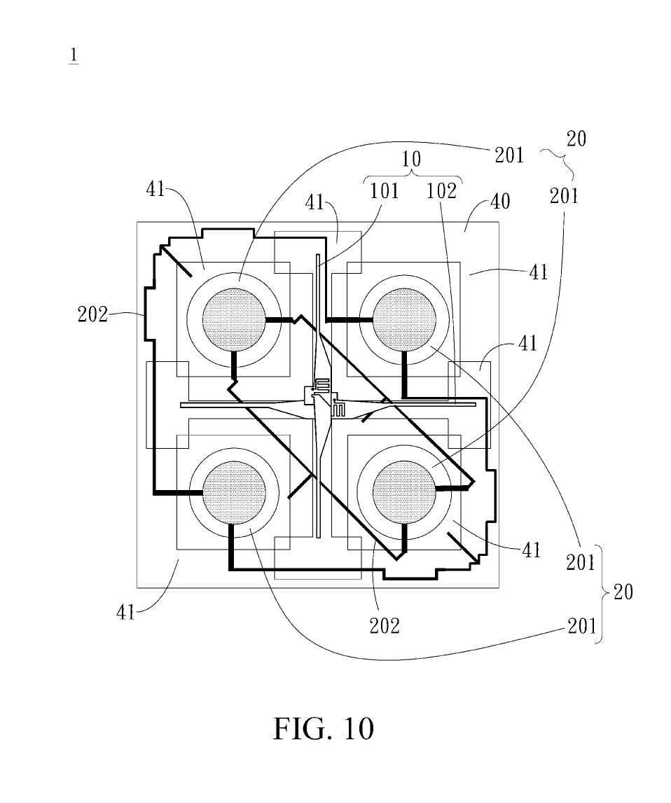

Please refer to FIG. 10, which is a schematic diagram showing a multiband antenna according to a third embodiment of the present invention. The multiband antenna according to the present invention may comprise a first-band antenna assembly and a plurality of second-band antenna assemblies; in the embodiment, the first-band antenna assembly is a low-band antenna assembly and the second antenna assemblies are mid-band antenna assemblies. As shown in FIG. 10, the multiband antenna 1 includes a low-band antenna assembly 10, two mid-band antenna assemblies 20 and a bottom panel 40. The low-band antenna assembly 10 is composed of a first dipole antenna 101 and a second dipole antenna 102 that are arranged intersecting to each other. Moreover, each of the two mid-band antenna assemblies 20 is a dual-feed patch antenna array consisting of two connecting mid-band antennas 201, whereas the two mid-band antenna assemblies are respectively and alternatively disposed on two diagonal lines of the rectangle-shaped bottom panel 40.

By the arrangement described in the above embodiment, the directionality of the multiband antenna 1 is enhanced. Moreover, since the gain of the multiband antenna 1 is also being improved by it antenna array design, the beamwidth of its mid-band antenna assembly 20 can achieve 30 deg, whereby one of the two mid-band antenna assemblies can be removed for enabling the desired beamwidth to be increased, and consequently, various efficiency and performance characteristic can be achieved so that the multiband antenna can be adapted for applications of different requirements. From the above description, it is noted that the multiband antenna is not restricted to three bands that it can be adapted for two bands or more than three bands.

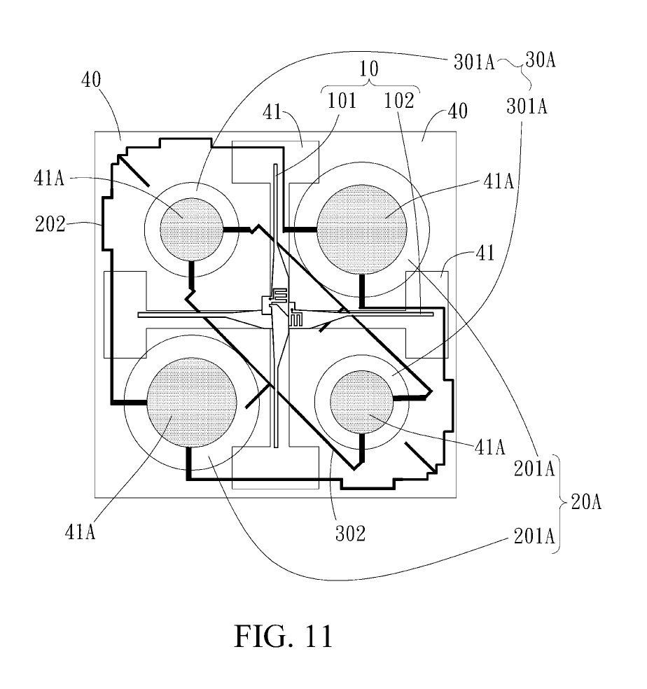

Please refer to FIG. 11, which is a schematic diagram showing a multiband antenna according to a fourth embodiment of the present invention. Similarly in the fourth embodiment shown in FIG. 11, the first dipole antenna 101 and the second dipole antenna 102 are disposed respectively on a substrate 41 while allowing the signals thereof to be fed to the rectangle-shaped bottom panel 40 via transmission lines. Moreover, the high-band antennas 301A and the mid-band antennas 201A are patch antennas made of metals.

However, each of the high-band antennas 301A and the mid-band antennas 201A are patch antennas as well as their respective transmission frameworks are made of metals, which is different from the other embodiments mentioned hereinbefore. In this fourth embodiment, the high-band antennas 301A and the mid-band antennas 201A are disposed respectively on a metal substrate 41A while being mounted at different heights on a metal layer of the rectangle-shaped bottom panel and allowing each to be excited by the coupling of the metal substrate 41A to the metal layer via their metal transmission lines, by that the metal substrate 41A can performed as one excitation and transmission media. In addition, the mid-band antennas 201A are connected into an array of mid-band antenna assembly 20A by the connection of the two transmission lines 202 of the metal substrate 41A; and similarly the high-band antennas 301A are connected into an array of high-band antenna assembly 30A by the connection of the two transmission lines 302 of the metal substrate 41A. Moreover, the mid-band antenna assembly 20A and the high-band antenna assembly 30A are respectively and alternatively disposed on two diagonal lines of the bottom panel 40.

The major difference between the fourth embodiment and the other embodiments mentioned hereinbefore is that: the high-band antennas 301 and the mid-band antennas 201 are made of metals and are not respectively disposed on a PCB board, but instead is disposed on a metal substrate 41A. Moreover, it is noted that there are a variety of metals capable of being selected and used to made the high-band antennas 301, the mid-band antennas 201 and the metal substrate 41A; and in this embodiment, the high-band antennas 301, the mid-band antennas 201 and the metal substrate 41A are made of tinned iron.

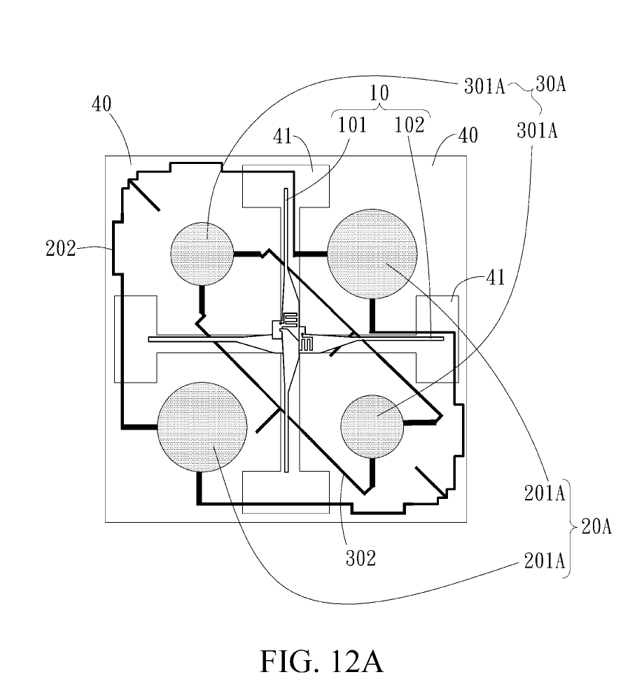

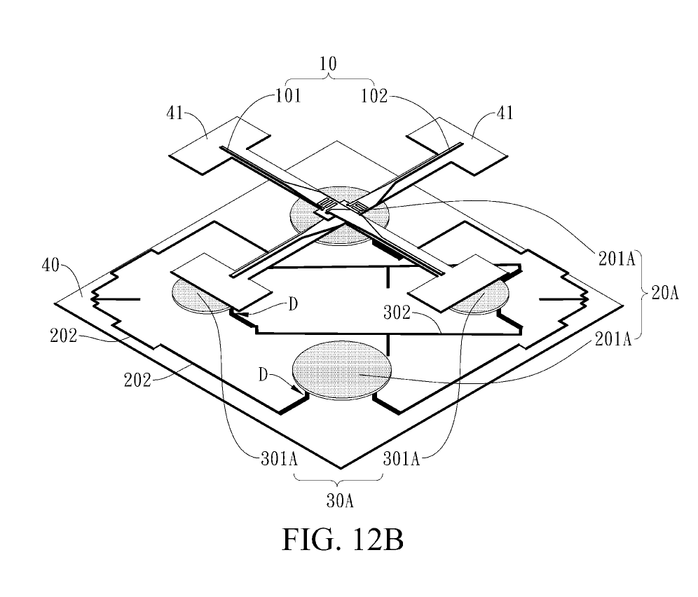

Please refer to FIG. 12A and FIG. 12B, which are respectively a first exemplary view and a second exemplary view of a multiband antenna according to a fifth embodiment of the present invention. In FIG. 12A, the first dipole antenna 101 and the second dipole antenna 102 are disposed respectively on a substrate 41 while allowing the signals thereof to be fed to the rectangle-shaped bottom panel 40 via transmission lines. Moreover, the high-band antennas 301A and the mid-band antennas 201A are patch antennas made of metals and are disposed respectively at different heights on the rectangle-shaped bottom panel 40.

As shown in FIG. 12B, the difference between the fifth embodiment and the other embodiments mentioned hereinbefore is that: the signal feed-in of each of the high-band antennas 301A and the mid-band antennas 201A is enabled via feed-in points D that are disposed engaging directly to the rectangle-shaped bottom panel 40. In addition, the mid-band antennas 201A are connected into an array of mid-band antenna assembly 20A by the connection of the two transmission lines 202; and similarly the high-band antennas 301A are connected into an array of high-band antenna assembly 30A by the connection of the two transmission lines 302. Moreover, the mid-band antenna assembly 20A and the high-band antenna assembly 30A are respectively and alternatively disposed on two diagonal lines of the bottom panel 40.

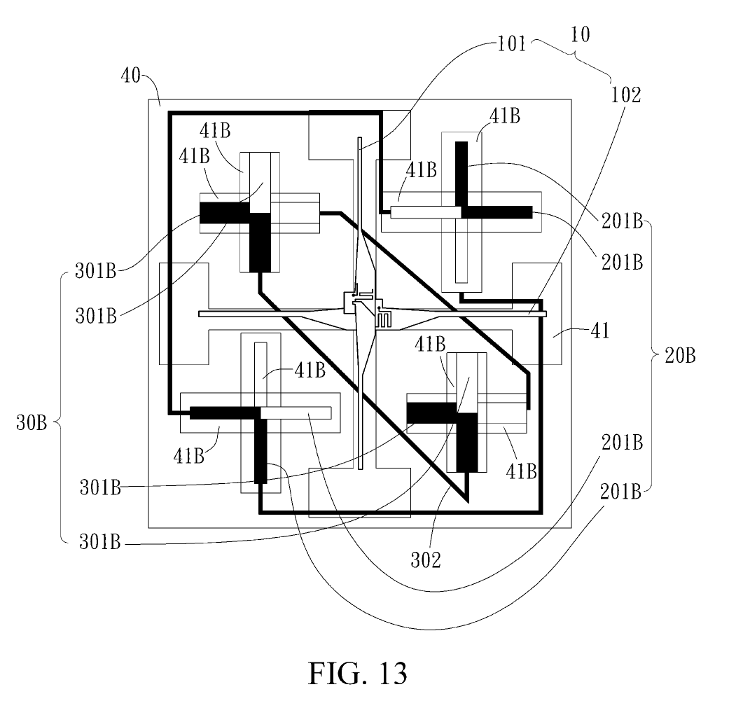

Please refer to FIG. 13, which is a schematic diagram showing a multiband antenna according to a sixth embodiment of the present invention. In this embodiment, the directionality of the multi-band antenna is achieved by the use of dipole antennas. As shown in FIG. 13, the first dipole antenna 101 and the second dipole antenna 102 are disposed respectively on a substrate 41 while allowing the signals thereof to be fed to the rectangle-shaped bottom panel 40 via transmission lines.

The difference between the fourth embodiment and the other embodiments mentioned hereinbefore is that: the high-band antennas 301B and the mid-band antennas 201B are dipole antennas that are disposed respectively on a reflective substrate 41B while being mounted at different heights on the rectangle-shaped bottom panel 40. Similarly, the high-band antenna assembly 30B is composed of a plurality of connecting high-band antennas 301B that are arranged intersecting with each other; and the mid-band antenna assembly 20B is composed of a plurality of connecting mid-band antennas 201B that are arranged intersecting with each other.

In this sixth embodiment, the high-band antenna assembly 30B is composed of two sets of high-band antennas 301B that are arranged orthogonal to each other, and the two sets of high-band antennas 301B are connected to each other via transmission lines 302 in to an antenna array for signal feed-in and gain improvement; and the mid-band antenna assembly 20B is composed of two sets of mid-band antennas 201B that are arranged orthogonal to each other, and the two sets of mid-band antennas 201B are connected to each other via transmission lines 202 in to an antenna array for signal feed-in and gain improvement. As shown in FIG. 13, the mid-band antenna assembly 20B and the high-band antenna assembly 30B are respectively and alternatively disposed on two diagonal lines of the bottom panel 40, by that a orthogonal polarization can be achieved. Moreover, it is noted that the transmission lines 202, 302 used in this embodiment can be any microstrip lines, or cables, etc.

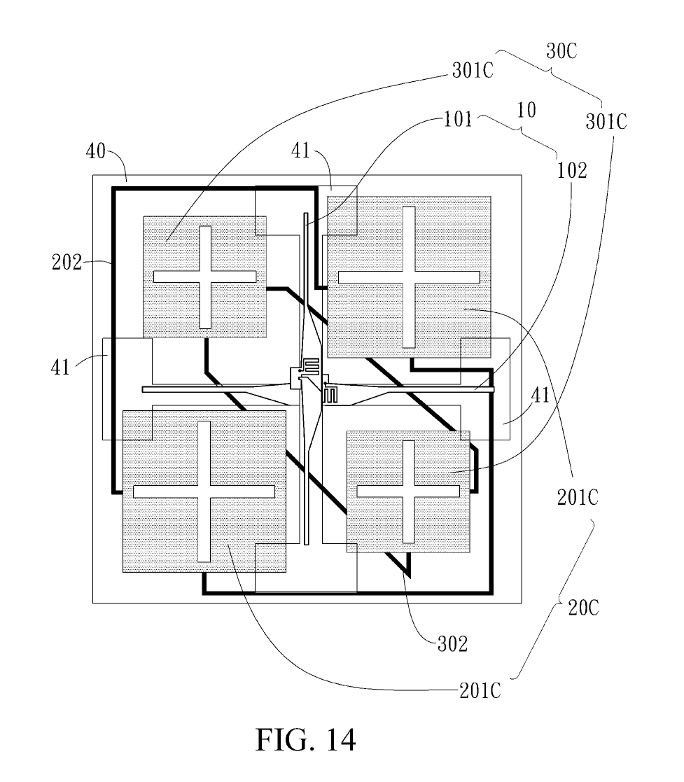

Please refer to FIG. 14, which is a schematic diagram showing a multiband antenna according to a seventh embodiment of the present invention. In this embodiment, the directionality of the multi-band antenna is achieved by the cooperation between slot antennas and its bottom panel. As shown in FIG. 14, the first dipole antenna 101 and the second dipole antenna 102 are disposed respectively on a substrate 41 while allowing the signals thereof to be fed to the rectangle-shaped bottom panel 40 via transmission lines. Nevertheless, the difference between the fourth embodiment and the other embodiments mentioned hereinbefore is that: the high-band antennas 301C and the mid-band antennas 201C are slot antennas that are disposed respectively on a reflective substrate; and the mid-band antennas 201C are connected via the two transmission lines 202 into an array of mid-band antenna assembly 20C, while the high-band antennas 301C are connected via the two transmission lines 302 into an array of high-band antenna assembly 30C. As shown in FIG. 14, the mid-band antenna assembly 20C and the high-band antenna assembly 30C are respectively and alternatively disposed on two diagonal lines of the bottom panel 40, by that an orthogonal polarization can be achieved. Moreover, it is noted that the transmission lines 202, 302 used in this embodiment can be any microstrip lines, or cables, etc.

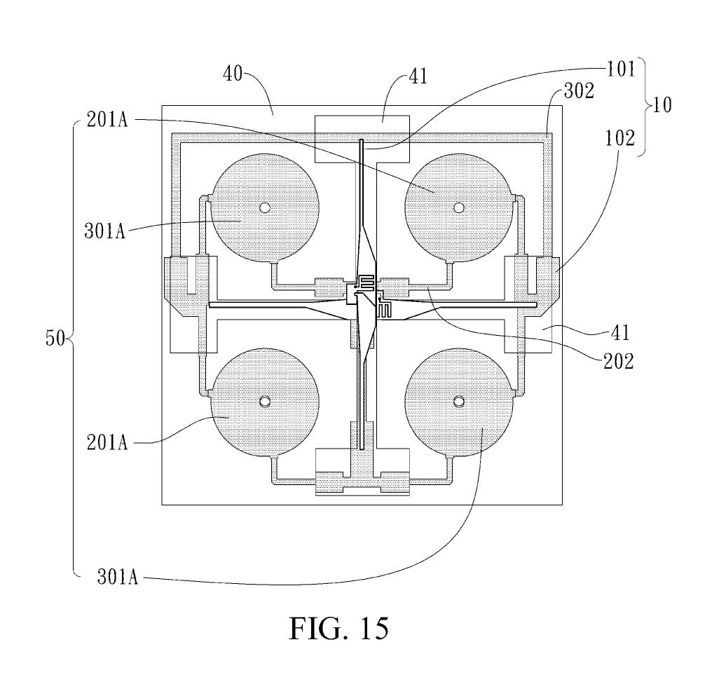

Please refer to FIG. 15, which is a schematic diagram showing a multiband antenna according to an eighth embodiment of the present invention. As the eighth embodiment shown in FIG. 15, the first dipole antenna 101 and the second dipole antenna 102 are disposed respectively on a substrate 41 while allowing the signals thereof to be fed to the rectangle-shaped bottom panel 40 via transmission lines. Moreover, the high-band antennas 301A and the mid-band antennas 201A are patch antennas made of metals that are disposed engaging directly to the rectangle-shaped bottom panel 40 for signal feed-in.

The difference between the eighth embodiment and the other embodiments mentioned hereinbefore is that: the high-band antennas 301A and the mid-band antennas 201A are disposed respectively on the four corners of the rectangle-shaped bottom panel 40 at the same height, while being connected via transmission lines 202, 302 into an antenna assembly 50, and enabling the polarization of the primary antenna of the antenna assembly 50 to be arranged orthogonal to the polarization of the diversity antenna of the antenna assembly 50. As the antenna assembly 50 is formed as a 2×2 antenna array of the connecting high-band antennas 301A and the mid-band antennas 201A, the gain of the resulting multiband-antenna is enhanced with more concentrated beamwidth.

To sum up, first, by arranging more than three antennas of different operating frequencies at different heights on a bottom panel, the space utilization efficiency of the relating multiband antenna can be enhanced effectively so that the size of the multiband antenna is minimized. Secondly, by the specific design of the multiband antenna for arranging more than three antennas of different operating frequencies on one substrate without causing the three antennas to interfere with one another, the performance of the multiband antenna is optimized. Last but not least, the design of the multiband antenna of the present invention relating to its configuration and parts arrangement can be varied in many ways for achieving different characteristics in beam width, polarization and so on, the multiband antenna is very flexible in usage and thus can be applied in various applications.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A multiband antenna, comprising:
a low-band antenna assembly, composed of a first dipole antenna and a second dipole antenna that are arranged intersecting with each other;
at least one mid-band antenna assembly, each composed of a plurality of connecting mid-band antennas;
at least one high-band antenna assembly, each composed of a plurality of connecting high-band antennas; and
a bottom panel, provided for the low-band antenna assembly, the at least one mid-band antenna assembly and the at least one high-band antenna assembly to be disposed thereon;
wherein, the low-band antenna assembly is disposed on top of the at least one mid-antenna assembly and the at least one high-band antenna assembly.

2. The multiband antenna of claim 1, wherein each of the mid-band antennas and the high-band antennas is an antenna selected from the group consisting of: a patch antenna, a dipole antenna, and a slot antenna.

3. The multiband antenna of claim 1, wherein the operating frequency of the at least one mid-band antenna assembly is ranged between 1.5 times and 2 times the operating frequency of the low-band antenna assembly, while the operating frequency of the at least one high-band antenna assembly is about higher than 2 times the operating frequency of the low-band antenna assembly.

4. The multiband antenna of claim 1, wherein the sizes and the heights of disposition of the low-band antenna assembly, the at least one mid-band antenna assembly and the at least one high-band antenna assembly are increased or decreased proportionally according to their operating frequencies.

5. The multiband antenna of claim 1, wherein the first dipole antenna and the second dipole antenna are arranged orthogonal to each other.

6. The multiband antenna of claim 1, wherein the first dipole antenna, the second dipole antenna, the plural high-band antennas and the plural mid-band antennas are disposed respectively on a substrate while being arranged at different heights on the bottom panel by the use of a fixing structure; the signals of the first dipole antenna and the second dipole antenna are fed to the bottom panel via transmission lines; each of the mid-band antennas further comprises matching circuit transmission lines and the signals thereof are being feed-in via feed-in points of the bottom panel, whereas the impedance matching of the plural mid-band antennas is achieved by the connecting the matching circuit transmission lines; and each of the high-band antennas further comprises matching circuit transmission lines and the signals thereof are being feed-in via feed-in points of the bottom panel, whereas the impedance matching of the plural high-band antennas is achieved by the connecting the matching circuit transmission lines.

7. A multiband antenna, comprising:
a first-band antenna assembly, composed of a first dipole antenna and a second dipole antenna that are arranged intersecting with each other;
a plurality of second-band antenna assemblies, each composed of a plurality of connecting second-band antennas; and
a bottom panel, provided for the first-band antenna assembly, the second-band antenna assemblies to be disposed thereon;
wherein, the operating frequency of the second-band antenna assemblies is higher than the operating frequency of the first-band antenna assembly, and the first-band antenna assembly is disposed on top of the second-band antenna assemblies.

8. The multiband antenna of claim 7, wherein each of the second-band antennas is an antenna selected from the group consisting of: a patch antenna, a dipole antenna, and a slot antenna.

9. The multiband antenna of claim 7, wherein the operating frequency of the second-band antenna assembly is higher than 1.5 times the operating frequency of the first-band antenna assembly.

10. The multiband antenna of claim 7, wherein the sizes and the heights of disposition of the first-band antenna assembly and the two second-band antenna assemblies are increased or decreased proportionally according to their operating frequencies.

11. The multiband antenna of claim 7, wherein the first dipole antenna and the second dipole antenna are arranged orthogonal to each other.

12. The multiband antenna of claim 7, wherein the first dipole antenna, the second dipole antenna, the plural second-band antennas are disposed respectively on a substrate while being arranged at different heights on the bottom panel by the use of a fixing structure; the signals of the first dipole antenna and the second dipole antenna are fed to the bottom panel via transmission lines; each of the second-band antennas further comprises matching circuit transmission lines and the signals thereof are being feed-in via feed-in points of the bottom panel, whereas the impedance matching of the plural second-band antennas is achieved by the connecting the matching circuit transmission lines.
